(19) United States
(12) Patent Application Publication
(10) Pub. No.: US 2009/0266377 A1
(43) Pub. Date: Oct. 29, 2009

(54) APPARATUS AND METHOD FOR IMPRINTING SHAPED IMAGES ONTO HAIR

(76) Inventors: Susan M. Matsumoto, Lantana, FL (US); Melvin R. Kennedy, Lantana, FL (US); Jose Longoria, Miami, FL (US)

Correspondence Address: Leason Ellis LLP, 81 Main Street, Suite 503, White Plains, NY, 10601, US

(21) Appl. No.: 12/326,747

(22) Filed: Dec. 2, 2008

Related U.S. Application Data
(60) Provisional application No. 61/125,619, filed on Apr. 28, 2008.

(51) Int. Cl. A61Q 5/00; A45D 40/00; A45D 40/26

(52) U.S. Cl. 132/202; 132/319; 132/320

(57) ABSTRACT

An applicator for applying an image onto hair according to one embodiment includes a container holding a colored gel composition that forms the image and an at least partially hollow stencil element securely attached to the container. The stencil element includes a screen that partitions the stencil element into a first portion and a second portion. The first portion is in fluid communication with the interior of the container and contains a first cavity that is preshaped in the form of the image to be applied. The first cavity is formed adjacent a first side of the screen. The second portion is located on an opposite side of the screen and contains a second cavity that is also preshaped in the form of the image to be applied, whereby the shape of the gel composition is preformed in the first cavity and is maintained as the gel composition passes through the screen and fills the second cavity for application onto the hair as the image.

### CROSS REFERENCE TO RELATED APPLICATION

The present application claims the benefit of U.S. patent application Ser. No. 61/125,619, filed Apr. 28, 2008, which is hereby incorporated by reference in its entirety.

### TECHNICAL FIELD

The present invention relates to image transfer and in particular, to an apparatus and method for imprinting decorative colored custom shapes onto hair using a colored and/or glitter-filled gel formulation contained within a dispenser.

### BACKGROUND

There are currently a number of products that can temporarily add color and/or glitter to hair. The products take advantage of fashion trends that are popularized by rock stars, fashion models, celebrities and other trend-setting personages. Many of these products are powder-based, offering the user the ability to add color and/or glitter in a general area or throughout the entire hairstyle. Powder-based products can often be found in vials or containers that require manual application or roll-on applicators that can be used to add streaks of color/glitter to the hair. Alternatively, the powder-based products can be infused in aerosol dispensers that add a hint of color/glitter to a wide area of the hair.

Color and/or glitter can also be added by means of a gel-based product which allows for relatively more specific placement of the color and/or glitter; however, this type of product often involves a messy, manual application requiring an extensive cleanup of either hands or grooming tools. The color/glitter gel is squeezed out from the tubes or bottles and placed either directly into the hair or onto a hand for placement on the hair. The gel can then be manipulated through the hair or combed into place. These products can offer coverage to strands of hair or to an area of hair, but do not offer anything further than adding color/glitter into the hair style.

There is thus a perceived need in the relevant market for an apparatus and method for applying color/glitter in specific, decorative shapes, while eliminating the need for any messy manipulation with hands or grooming tools.

### SUMMARY

An applicator for applying an image onto hair according to one embodiment includes a container holding a colored gel composition that forms the image and an at least partially hollow stencil element securely attached to the container. The stencil element includes a screen that partitions the stencil element into a first portion and a second portion. The first portion is in fluid communication with the interior of the container and contains a first cavity that is preshaped in the form of the image to be applied. The first cavity is formed adjacent a first side of the screen. The second portion is located on an opposite side of the screen and contains a second cavity that is also preshaped in the form of the image to be applied, whereby the shape of the gel composition is preformed in the first cavity and is maintained as the gel composition passes through the screen and is loaded into the second cavity for application onto the hair as the image.

A method for applying an image onto hair includes the step of applying a force to a wall of a container that holds a colored gel composition that forms the image to cause the composition to be discharged from an interior of the container into a first section of a custom shaped applicator. The first section has a custom shaped interior space that mirrors the shape of the image. The applicator also includes a screen that is disposed across the custom shaped interior space, as well as a distal space that is located distal to an exposed outer surface of the screen, whereby continued application of the force to the container causes the gel composition to pass through the screen and be loaded within the distal space where it is ready for application to the hair resulting in the image being formed on the hair.

These and other aspects, features and advantages shall be apparent from the accompanying Drawings and description of certain embodiments of the invention.

### BRIEF DESCRIPTION OF THE DRAWINGS

FIG. 1 is a top plan view of strands of hair with a plurality of decorative, colored images printed thereon;

FIG. 2 is a front perspective view of an applicator according to one embodiment for applying the decorative, colored image onto the hair;

FIG. 3 is an exploded front perspective view of the various components of the applicator of FIG. 2;

FIG. 4 is a cross-sectional view of the various components of the applicator;

FIG. 5 is side perspective view of an applicator in a completely assembled condition;

FIG. 6 is an exploded side perspective view of the applicator of FIG. 5; and

FIG. 7 is a perspective view of different interchangeable stencil elements for use in the applicator of the present invention.

### DETAILED DESCRIPTION OF CERTAIN EMBODIMENTS OF THE INVENTION

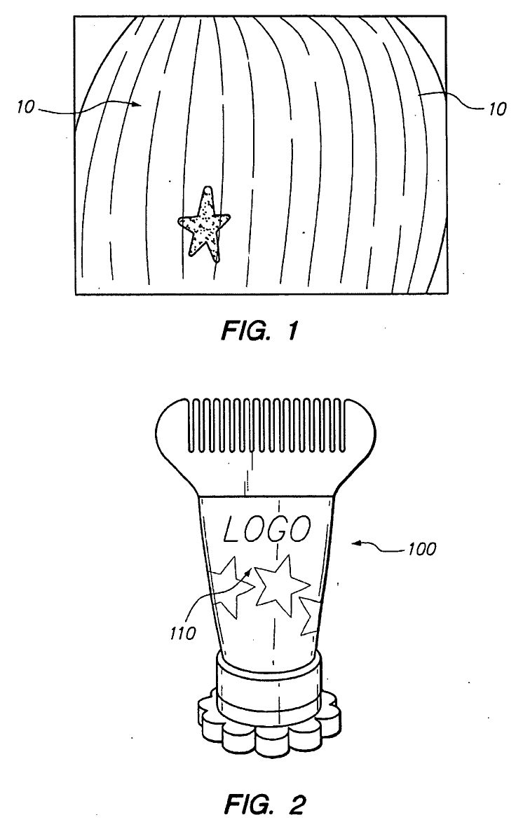

FIG. 1 shows a decorative image 10 that has been transferred onto the hair of a person. The outline and border of the image 10 is maintained during the transfer to produce a well defined image that is printed on the hair. The image 10 can be formed in any number of different colors, even including multi-colors, and also, the image 10 can include glitter that is dispersed throughout. The image 10 can take any number of different colors, shapes and sizes and can have any number of different themes. For example, the image 10 can be related to a theme, such as animals, sports teams' logos, holiday related, music related, etc. or it can be simply an object, such as a star, as illustrated in FIG. 1, a heart, a butterfly, etc.

The image is formed of a material that adheres to the hair for a period of time and has the proper consistency and other properties to allow the person to move without causing undesired flow of the image. The material thus has a specific consistency and chemistry to facilitate the easy application of a decorative shape onto the hair so that it: (1) adheres to the hair sufficiently and in such quantity as to remain in place on the hair over a period of time while still retaining its specific shape; (2) dries quickly in the air; and (3) washes out with soap and water. One suitable material is a gel composition that has the proper consistency (viscosity) for the intended application in that the gel composition can be manipulated into the desired shape, applied to the hair and then maintain the desired shape after application as opposed to running or otherwise losing its shape after application to the hair. The gel composition is selected so that the glitter remains in suspension and does not migrate to one location of the container that holds the gel and glitter composition. The gel composition can be similar to standard hair grooming gel.

In addition, the gel composition preferably includes glitter. The glitter is dispersed throughout the gel composition so that when the gel composition is applied to the hair, the glitter is likewise transferred onto the hair. As a result of the glitter being substantially uniformly dispersed throughout the gel composition, the image that is formed on the hair similarly has glitter at least substantially uniformly distributed throughout the image. The glitter can have any number of different colors and can even come in different shapes. The glitter and the gel composition can be color coordinated with one another. For example, the glitter can have a silver color and the gel composition can have a red color. It will be appreciated that the glitter can be multi-color glitter that comes in a number of different colors. The glitter is conventional glitter that is formed of a plastic material or foil product. As previously mentioned, the glitter can be cut to have any number of different shapes.

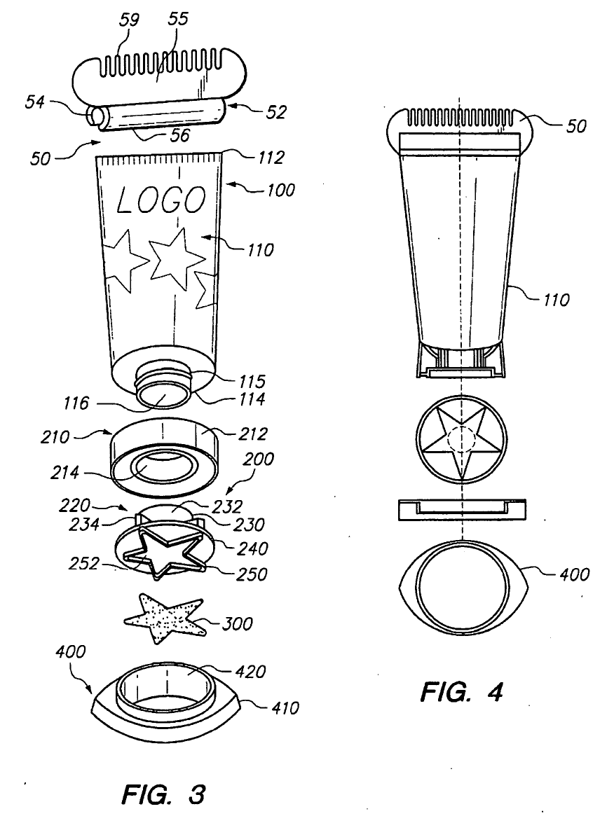

As shown in FIGS. 2-3, the present invention is directed to an applicator 100 that is used to apply the gel/glitter composition. The applicator 100 includes a number of different components that are coupled to one another. The applicator 100 includes a container 110 that stores the gel/glitter composition. The container 110 is a hollow, flexible structure that includes a closed first end 112 and an open second end 114. The second end 114 includes an opening 116 through which the contents of the container 110 are discharged. The container 110 can thus be of a plastic squeeze bottle or tube type that permits the user to squeeze the container 110 to discharge the contents of the container 110. The outer surfaces of the container 110 permit the display of indicia, such as a brand of the product and other fanciful indicia.

At the second end 114, the container 110 has a neck or the like 115, with the distal end of the neck 115 defining the opening 116. The outer surface of the neck 115 can contain threads that permit a disposable or removable cap, such as a screw cap, to be threadingly coupled thereto. In one embodiment, the closed first end 112 is defined by a straight, sealed end of the container 110, while the open second end 114 has more of a circular shape and the neck 115 can have a cylindrical shape.

The container 110 can be a one (1) ounce standard tube and can be transparent or semi-transparent to allow the color of the glitter to be visible. In the case of using a colored gel composition, the transparent or semi-transparent nature of the container 110 allows the color of the gel composition to also be visible.

One accessory that can be used with the container 100 is a removable comb member 50. The comb member 50 has a bottom clamp 52 that is configured to permit the comb member 50 to be removably secured to the closed first end 112 and a top comb portion 55 that is integrally connected to the clamp 52. The bottom clamp 52 can be formed of first and second clamp parts 54, 56 that are spaced from one another such that a space is formed between the two parts 54, 56. The clamp parts 54, 56 resemble jaw members that can be biased together and can move between an open position where the distance between the jaw members 54, 56 is at a greatest distance to allow insertion of the sealed end 114 of the container therebetween and a closed position where the distance between the jaw members 54, 56 is at a minimum distance.

The top comb portion 55 includes a substrate that extends upward from the jaw members 54, 56. Along a top edge of the substrate, a plurality of teeth 59 are formed and extend along a length of the top edge. The comb member 50 can therefore be easily attached to the container 100 (the sealed second end 114) and functions as a comb that can be used to comb the hair prior to applying the image 10 to the hair.

To place the comb member 50 onto the sealed second end 114, the jaw members 54, 56 are separated and then the second end 114 is inserted into the space therebetween and then the jaw members 54, 56 are biased back towards one another, thereby capturing the sealed second end 114 therebetween.

Alternatively, the jaw members 54, 56 do not have to be biased with respect to one another but instead can be rigidly formed jaw members 54, 56 and the distance between the members 54, 56 is slightly less than the thickness of the sealed second end 114 of the container 110 and therefore, a frictional fit is established between the comb member 50 and the container 110 by simply frictionally inserting the sealed second end 114 into the space between the members 54, 56.

As previously mentioned, the container 110 includes the premixed gel/glitter composition with the glitter being substantially uniformly dispersed (suspended) throughout the gel composition. The container 110 can be closed off by a cap that seals the contents therein. A foil seal can also be used for initial shipping of the container 110. When it is time for use of the applicator 100, the container 110 is readied by removing the cap and removing the foil seal. As described below, the container 110 is now ready for coupling to and use in the applicator 100.

In accordance with the present invention, the applicator 100 includes a number of components that mate together and with the container 110 to provide the decorative, colored image that has a specific shape chosen by the user. More specifically the applicator 100 has a stencil assembly 200 that is defined by a unique shape that itself defines the shape of the image that is applied onto the hair. The stencil assembly 200 includes a sleeve 210 that is configured to mate with the open end 112 of the container 110 and in particular, the sleeve 210 has an annular shape and is defined by a first outer annular wall 212 and a concentric second inner annular wall 214. A space is formed between the first and second walls 212, 214. The sleeve 210 is configured to securely mate with the container 110 and in particular, the neck 115 thereof resulting in the interior (bore) of the neck 115 being aligned with the interior (bore) of the second inner annular wall 214.

The stencil assembly 200 also includes a stencil element 220 that has a predefined shape that forms the image that is transferred onto the hair. The stencil element 220 is configured to mate with the sleeve 210. The stencil element 220 includes a first portion 230, a center portion 240 and a second portion 250.

The center portion 240 is a disk-shaped member and the first portion 230 is formed on one side of the disk-shaped member 240 and the second portion 250 is formed on the other side of the disk-shaped member 240. The first portion 230 is cylindrically-shaped and designed to mate with the sleeve 210 and more specifically, the first portion 230 is received within and between the second inner annular wall 214. The first portion 230 can actually have two sections, namely, a first section 232 that has a cylindrical tube-like construction and a second section 234 that has a predefined shape that corresponds to the shape of the image 10. In the illustrated embodiment, the image 10 is in the shape of a star and therefore, the second section 234 has a star shape in that a star shaped void or space is formed by the wall of the second section 234.

Since the first and second sections 232, 234 are in fluid communication with one another, the gel/glitter composition initially passes within and through the cylindrically shaped first section 232 and then enters the second section 234 that has a cavity that has a different shape then the cavity of the first section 232. As previously mentioned, the shape of the cavity of the second section 234 corresponds to the shape of the image 10 that is transferred onto the hair and therefore, the cavity of the second section 234 can have any number of different shapes, including a star (as shown), a heart, a butterfly, a flower, etc.

The center disk-shaped member 240 has an opening or bore formed therein that has the same shape as the cavity of the second section 234. In addition, the dimensions of the opening in the center disk-shaped member 240 should be at least substantially identical to the dimensions of the cavity of the second section 234. This allows the gel/glitter composition to flow seamlessly from the first portion 230, through the center disk-shaped member 240 and then into the second portion 250.

The second portion 250 has an interior cavity 252 that has the same shape as the cavity of the second section 234 and the opening formed through the center disk-shaped member 240. Once again, in the illustrated embodiment, the interior cavity 252 is star shaped since the image 10 that is applied onto the hair is star shaped. The dimensions of the interior cavity 252 can be the same as the dimensions of the cavity of the second section 234 and the opening formed through the center disk-shaped member 240 or the dimensions of the interior cavity 252 can be different. Preferably, the dimensions are the same or substantially the same.

The applicator 100 also includes a screen 300 that is part of the stencil assembly 200. The screen 300 is disposed within the stencil element 220 so that the gel/glitter composition that flows through the interior of the stencil element 220 must flow through the screen 300 before being transferred onto the hair. In accordance with the present invention, the screen 300 is positioned within the stencil element 220 such that there is a cavity or empty space both below (on one side of) the screen 300 and above (on the other side of) the screen 300. Both cavities on either side of the screen 300 are shaped cavities that have the same shape as the image that is ultimately transferred onto the hair. In other words, in the illustrated embodiment, both cavities on opposite sides of the screen 300 have a star shape. It will also be appreciated that the open portion of the screen 300, i.e., the portion of the screen 300, through which the gel/glitter composition flows likewise has the same shape as the image that is formed on the hair. Consequently, the gel/glitter composition is preformed into the desired shape before flowing through the screen and then after flowing through the screen, the gel/glitter composition maintains the preformed shape and is collected in a space before being delivered onto the hair.

In one embodiment, the screen element 300 is located where the center portion 240 is located and therefore, the gel/glitter composition is preformed to have the desired shape in the second section 234 of the first portion 230 before flowing through the screen 300 and into the second portion 250 where it maintains the desired preformed shape. The screen 300 can be coupled to the body the stencil element 220 of the stencil assembly 200 using conventional techniques, including but not limited to bonding the screen 300 to the stencil element 220 during a common mold process in which the stencil element 220 of the stencil assembly 200 is formed. Alternatively, a periphery of the screen 300 can be bonded (e.g., heat bonded) to the inner surface of a respective wall to which the screen 300 is attached. Other bonding techniques, such as use of an adhesive, can also be used. In addition, the screen 300 can be in molded with the part (stencil element 220) in which it seats.

The physical attributes, such as the mesh size, of the screen 300 are selected in view of the intended application. More particularly, the screen 300 resists the flow of the gel/glitter composition to cause the second section 234 of the first portion 230 to become fully loaded before the gel/glitter composition is able to pass through the screen 300 and into the second portion 250 which acts as a loading portion. The mesh size of the screen 300 is thus selected so that as the gel/glitter composition is introduced from the first section 232 (cylindrical section) of the first portion 230 into the second section 234 which has the desired, preformed shape, the gel/glitter composition does not pass directly through the second section 234 and into the second portion 250. Instead, the screen 300 prevents the gel/glitter composition from flowing too quickly through the second section 234 and causes a build up of the gel/glitter composition through and around the entire area of the second section 234 (the template for the image) before it flows out of the second section 234. Since the first section 232 has a cylindrical shape, the gel/glitter composition initially enters the center region of the second section 234, which occupies less than the entire area of the second section 234, and the resistance of the screen 300 causes the gel/glitter composition that contacts the screen 300 to flow and spread outwardly through the entire space of the second section 234 since the gel flows therein to areas of less resistance, thereby ensuring that the gel/glitter composition assumes the preformed shape before flowing through the screen 300 into the second portion 250. In other words, the gel/glitter composition is not squirted out of the container through the first portion 230, while air gets out of the second portion 250 creating an imperfect print.

Applicants have also discovered that the formation of a slight gap, namely, the space in the second portion 250 where the gel/glitter composition is loaded and collected prior to application onto the hair provides a remarkable difference in the quality of the print.

The screen 300 can be formed of a number of different materials and have different physical characteristics. For example, the screen 300 can be a nylon mesh screen that has a mesh size of between about 200 micron to 425 micron; between about 200 micron to 300 micron, or between about 200 micron to 250 micron; however, it will be appreciated that other mesh sizes can be used so long as the gel/glitter composition is properly loaded as described below.

The applicator 100 also includes a cap or base 400 that closes off the stencil assembly 200 when the applicator 100 is not in use. The illustrated cap 400 includes a base portion 410 and cap portion 420 that extends outwardly from the base portion 410. The base portion 410 can have a fanciful look, such as an oval or ellipse or “eye shaped” as illustrated. The cap portion 420 is configured to mate with the stencil assembly 220 and in particular, sealingly closes off the second portion 250 of the stencil element. When the applicator 100 is not in user, the cap 400 is placed on the stencil assembly 200 so as to cause a frictional fit between the cap portion 420 and the stencil assembly 200, e.g., the center portion 240 thereof.

It will be appreciated that the stencil element 220 is designed to be interchangeable used with the sleeve 210. Since the stencil element 220 is the component that individually and uniquely forms the shape of the image 10, the ability to interchange the stencil element 220 allows the user to easily select which image 10 is to be transferred onto the hair and also permits the user to transfer more than one image 10 onto the hair. This allows the user to easily create a customized look by using multiple stencil assemblies 200 to place differently shaped objects onto the hair.

The use of the applicator 100 will now be described. The container 110 is first prepped for use by selecting the container 110 that holds the desired gel/glitter composition. The cap that initially is attached to the container 110 is removed and any protective cover, such as a foil seal, is removed from the open end of the container 110. The user next selects the desired stencil assembly 200 that will result in the desired object or image, such as a heart, star, butterfly, etc., being formed on a person's hair. The stencil element is securely coupled to the sleeve member which is itself coupled to the open end of the container 110 such that when the container 110 is squeezed, the contents of the container 110 are ejected from the container, through the central opening formed through the sleeve and then through the central opening formed through the stencil element.

More specifically, once the stencil assembly 200 is coupled to the container 110, the user squeezes the container 110 causing the gel/glitter composition to flow out of the container 110, through the central opening formed in the sleeve 210 and then into the first section 232 of the first portion 230 of the stencil element 220. Continued squeezing of the container 110 results in the gel/glitter composition flowing into custom shaped second section 234 of the first portion 230. As previously mentioned, the screen 300 prevents the gel/glitter composition from flowing freely into the second portion 250 and instead, results in the gel/glitter composition completely filling up the custom shaped second section 234. Continued squeezing of the container 110 causes the preloaded gel/glitter composition that completely occupies the custom shaped second section 234 to flow through the screen 300 and into the custom shaped second portion 250. It will be appreciated that the shape of the gel/glitter composition is maintained both immediately before it passes through the screen 300, as it passes through the screen 300 and then after it passes through the screen 300 and collects within the loading space (second portion 250). The gel/glitter composition thus completely occupies the custom shaped cavity of the second portion 250. In this loaded position, the gel/glitter composition is ready for being transferred onto the hair by simply pressing the exposed stencil assembly 200 against the hair.

When the loaded gel/glitter composition is squeezed out onto the hair, it is transferred onto the hair in the custom shape of the unique stencil assembly 200. For example, use of the illustrated star shaped stencil assembly 200 results in a colored star being formed on the hair. To form another star on the hair, the user simply needs to make sure that the custom shaped second portion 250 is fully filled with gel/glitter composition and the gel/glitter composition flows uniformly outwardly onto the hair.

In one embodiment, the user places the distal end of the second portion 250 into contact with the hair (head) and then squeezes the container 110 to cause the complete filling of the cavity of the second portion 250 and then the outflow of the gel/glitter composition onto the hair. In this manner, the user will feel increased resistance as the composition is forced through the screen 300 and into and through the second portion 250 and then onto the hair. This alerts the user that the image transfer process is proceeding. It will also be appreciated that the second portion 250 may be slightly spaced from the hair and thus may not be in exact physical contact with the hair as the gel/glitter composition flows onto the hair.

In an alternate embodiment, the gel/glitter composition can be “pre-loaded” into the second portion 250. In other words, the cavity of the second portion 250 can be filled with the gel/glitter composition as the stencil element 220 is spaced from the head away from contact with the hair so that the user can view the cavity of the second portion 250 and the filling thereof. After uniformly and completely filling the cavity of the second portion 250, the user then places the distal end of the second portion 250 against the hair.

The applicator 100 provides the user with tactile and other feedback to alert the user when the gel/glitter composition is properly loaded. In particular, when squeezing the container 110, the user will feel a first level of resistance as the gel/glitter composition is first discharged from the container 110 through the neck 115 thereof. This results since the gel/glitter composition must be squeezed through an area of reduced diameter (the neck 115) to allow the gel/glitter composition to be fed into stencil assembly 200. The user will then feel a second feeling of increased resistance as the gel/glitter composition contacts the screen 300 and as previously mentioned, the mesh structure of the screen prevents the gel/glitter composition from freely flowing therethrough but rather provides flow resistance that forces the gel/glitter composition to flow throughout the entire preshaped cavity that is formed on the side of screen closest to the container. Once sufficient force is generated by the user by continued squeezing of the container 110, the gel/glitter composition that has assumed the shape of the preshaped cavity is forced through the screen 300 where it is then loaded into the cavity of the second portion 250 for direct application onto the hair, with the applicator being already placed in contact with the hair as the gel/glitter composition is forced into the cavity of the second portion 250 or when this cavity is “pre-loaded” with the applicator being spaced from the head.

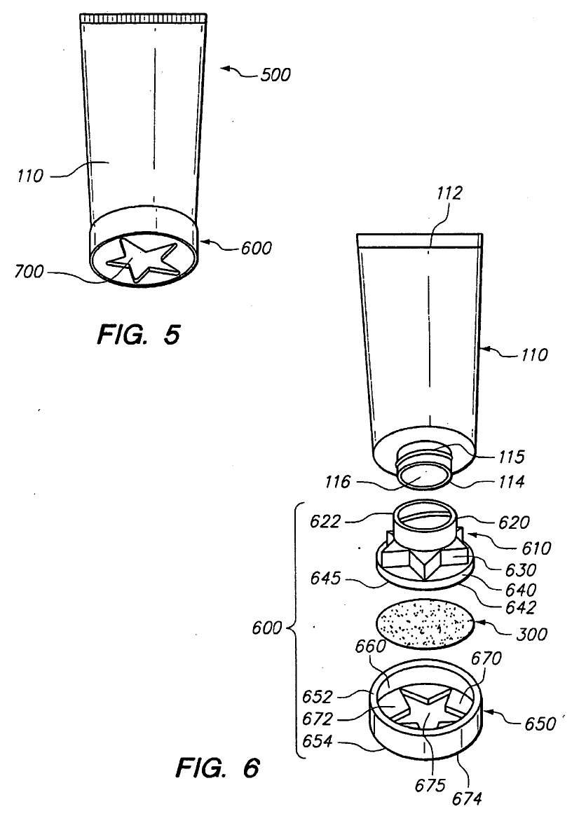

FIGS. 5 and 6 show an applicator 500 that is similar to applicator 100 and therefore, common elements are numbered alike. At the second end 114, the container 110 has a spout or the like 115, with the distal end of the spout 115 defining the opening 116 through which the contents are dispensed. The outer surface of the spout 115 can contain threads that permit a disposable or removable cap, such as a screw cap, to be threadingly coupled thereto. As previously mentioned, the container 110 includes the premixed gel/glitter composition with the glitter being substantially uniformly dispersed (suspended) throughout the gel composition.

In accordance with the present invention and similar to the first embodiment, the applicator 500 includes a number of components that mate together and with the container 110 to provide the decorative, colored image that has a specific shape chosen by the user. More specifically, the applicator 500 has a stencil assembly 600 that is defined by a unique shape that itself defines the shape of the image that is applied onto the hair.

The stencil assembly 600 includes a first part 610 that is coupled to the container 110 for initially receiving the premixed gel/glitter composition. The part 610 has a first section 620 that is configured to sealingly mate with the spout 115 to allow the contents of the container 110 to be received therein. For example, the first section 620 can be a cylindrical structure (hollow boss structure) that includes inner threads 622 that threadingly engage and mate with the threads formed on the spout 115. The length of the first section 620 is such that when the first part 610 is threadingly secured to the spout 115, at least a substantial length of the spout 115 is contained within the inner bore (inner cavity) of the first section 620.

The first part 610 includes a second section 630 that can be referred to as an intermediate chamber that receives the gel/glitter composition as it passes out of the first section 620. In contrast to the first section 620, the second section 630 does not have a standard tube-shape (hollow cylindrical structure) but instead it has a custom shape depending upon the image that is to be applied onto the hair. In particular, a hollow interior of the second section 630 has a custom shape. For example, in the illustrated embodiment, the second section 630 has a star shaped cavity. As a result, when the container 110 is squeezed, the premixed gel/glitter composition is discharged from the tube-shaped first section 620 into the second section 630 where it flows throughout the custom shaped cavity to assume a desired shape, namely the shape of the image to be applied.

The first part 610 also includes a distal section 640 with the second section 630 being located between the first section 620 and the distal section 640. The distal section 640 has a disk-like or wafer-like shape; however, it includes an opening or bore that is formed therein and has the same shape as the interior cavity of the second section 630. In other words, the opening that is formed in and through the distal section 640 is the same shape and dimensions as the custom shaped interior cavity of the second section 630, thereby allowing the gel/glitter composition to flow smoothly and uninterrupted from the second section 630 to the distal section 640. An exposed outer surface 645 at the distal end 642 of the distal section 640 can be a smooth surface.

The stencil assembly 600 also includes the screen 300 which has been previously discussed herein. For example, the screen 300 can be in the form of a circular mesh screen that has the properties and physical characteristics (mesh size) disclosed hereinbefore.

The stencil assembly 600 further includes a second part 650 that mates with the first part 610. The second part 650 can be referred to as a stencil component and is a generally hollow structure. For example, the second part 650 can be a hollow cap-like structure that is open at a first end 652 and partially open at a second end 654. Extending between the first and second ends 652, 654 is a side wall 660 which in this case is an annular shaped wall and at the second end 654, a wall 670 is formed and is connected to the side wall 660. The wall 670 has a predetermined thickness and due to the annular shape of the side wall 660, the wall 670 has a circular shape. The wall 670 has an inner surface 672 and an outer surface 674. As described below, when the components are assembled, the inner surface 672 faces screen 300.

In accordance with the present invention, the wall 670 has an opening 675 formed therethrough. For example, the opening 675 is centrally located in the wall 670. The opening 675 has a specific shape and in particular, the opening 675 at least substantially matches the custom shape of the opening that is formed in and through the distal section 640 and the custom shaped interior cavity of the second section 630. The opening 675 functions as an outlet for the gel/glitter composition. The opening 675 is also aligned with the opening that is formed in and through the distal section 640 and the custom shaped interior cavity of the second section 630 when the first and second parts 610, 650 and the screen 300 are assembled.

When assembled, the screen 300 is disposed across and over the outer surface 645 of the distal section 640 and is disposed across the inner surface 672 of the wall 670. It will be appreciated that the screen 300 thus covers the custom-shaped opening formed through the distal section 640 and the opening 675 formed through the wall 670. Any number of different techniques can be used for attaching the screen 300 between the first and second parts 610, 650 including but not limited to bonding techniques, mechanical attachment, use of adhesives, in-molding, etc. For example, the screen 300 can be heat sealed to the distal section 640 or to the wall 670 during the molding process in which the stencil assembly is formed.

When the screen 300 is securely attached to both the first part 610 and the second part 650, a small inner space or compartment 700 of a given height that is defined by the thickness of the wall 670 is formed. As with the previously described embodiment, Applicants have discovered that the formation of a slight gap, namely, the space 700, where the gel/glitter composition is loaded and collected after passing through the screen 300 but prior to application onto the hair provides a remarkable difference in the quality of the print. Once again, as described hereinbefore, the gel/glitter composition can be loaded into the space 700 with the distal end of the second part 650 being in direct contact with the hair (head) or alternatively, the second part 650 can be spaced from the hair (not in direct contact) and the gel/glitter composition is “preloaded” into the cavity of the second part 650 and then the applicator is placed against the hair.

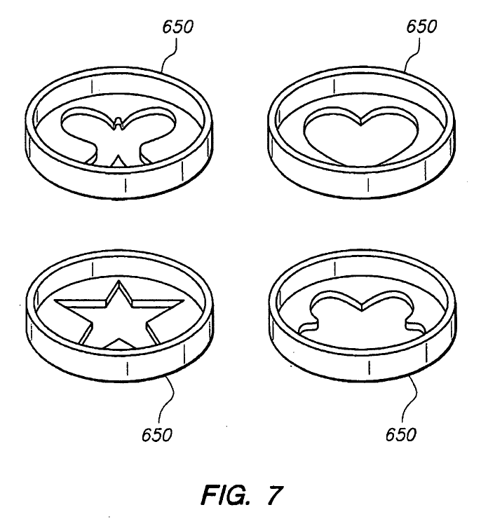

FIG. 7 shows a number of different custom stencil elements 650 that can be used interchangeably with the corresponding custom shaped first parts 610.

While the invention has been described in connection with certain embodiments thereof the invention is capable of being practiced in other forms and using other materials and structures. Accordingly, the invention is defined by the recitations in the claims appended hereto and equivalents thereof.

What is claimed is:

1. An applicator for applying an image onto hair comprising:
a container holding a colored gel composition that forms the image; and
an at least partially hollow stencil element securely attached to the container, the stencil element including a screen that partitions the stencil element into a first portion and a second portion, the first portion being in fluid communication with the interior of the container and containing a first cavity that is preshaped in the form of the image to be applied, the first cavity being formed adjacent a first side of the screen, the second portion being located on an opposite side of the screen and containing a second cavity that is also preshaped in the form of the image to be applied, whereby the shape of the gel composition is preformed in the first cavity and is maintained as the gel composition passes through the screen and is loaded into the second cavity for application onto the hair as the image.

2. The applicator of claim 1, wherein an exposed area of the screen has the same shape as the shape of the image to be applied onto the hair.

3. The applicator of claim 1, wherein the first portion has a first section with an opening that first receives the colored gel composition from the interior of the container, the first section opening into the first cavity which has a different shape than the opening of the first section.

4. The applicator of claim 1, wherein the opening of the first section has a cylindrical shape that is complementary to an opening in a neck portion of the container through which the gel composition is discharged from the container

5. The applicator of claim 1, wherein the gel composition includes glitter that is at least uniformly suspended throughout the gel composition.

6. The applicator of claim 5, wherein the color of the gel composition is at least predominantly due to the glitter being colored.

7. The applicator of claim 1, wherein the stencil element is detachably attached to an open end of the container, thereby permitting interchangeability of the stencil elements.

8. The applicator of claim 1, wherein a mesh size of the screen is selected so that the screen offers sufficient resistance to cause the gel composition to at least substantially fill up and occupy the first cavity before flowing through the screen into the second cavity.

9. The applicator of claim 8, wherein the mesh size is between about 200 micron and 250 micron.

10. The applicator of claim 1, wherein the screen and the stencil element are integrally formed as a single structure in an in-situ molding process.

11. The applicator of claim 1, wherein the second cavity is located at the distal end of the stencil element and is open and exposed for intimately contacting the hair to deliver the gel composition from the container onto the hair.

12. The applicator of claim 1, wherein a consistency of the gel composition is selected so that colored glitter is generally uniformly suspended throughout the entire gel composition and remains so over an extended period of time.

13. The applicator of claim 1, wherein the stencil element is coupled to a hollow sleeve that is securely coupled to an open neck portion of the container through which the gel composition is discharged.

14. A method for applying an image onto hair comprising the step of:
applying a force to a wall of a container that holds a colored gel composition that forms the image to cause the composition to be discharged from an interior of the container into a first section of a custom shaped stencil, the first section having a custom shaped interior space that mirrors the shape of the image, the stencil including a screen that is disposed across the custom shaped interior space, wherein the stencil includes a distal space that is located distal to an exposed outer surface of the screen,
whereby continued application of the force to the container in proximity to the hair causes the gel composition to pass through the screen and be loaded within the distal space resulting in the image being formed on the hair.

15. The method of claim 14, wherein the gel composition maintains its custom shape as it passes through the screen and is loaded in the distal space where it at least substantially occupies the entire distal space.

16. The method of claim 14, wherein the gel composition includes glitter that is at least uniformly suspended throughout the gel composition.

17. The method of claim 14, wherein the step of applying a force comprises the steps of:
applying a first force that causes the composition to flow into the first section of the stencil, whereby a resistance of the screen causes the composition to flow within and at least substantially fill the custom shaped interior space of the first section prior to the composition flowing through the screen; and
applying a second force that causes the composition to overcome the resistance of the screen and flow into and at least substantially fill the distal space for application to the hair.

18. The method of claim 14, wherein a distal end of the stencil is placed in direct contact with the hair prior to applying force to the container to cause the gel composition to pass through the screen, fill the distal space and be applied onto the hair.

19. A method for applying multiple images onto hair comprising the step of:
applying a force to a wall of a container that holds a colored gel composition that forms the images to cause the composition to be discharged from an interior of the container into a first section of a custom shaped stencil, the first section having a custom shaped interior space that mirrors the shape of each image and defines a custom pattern, the stencil including a screen that is disposed across the custom shaped interior space, wherein the stencil includes a distal space that is located distal to an exposed outer surface of the screen,
applying a first image of the custom pattern to the hair at a first location by continued application of the force to the container in proximity to the hair causing the gel composition to pass through the screen and completely fill the distal space before flowing onto the hair which results in the first image being formed on the hair; and
applying a second image of the custom pattern to the hair at a second location different from the first location by application of force to the container in proximity to the hair causing the gel composition to pass through the screen and completely fill the distal space before flowing onto the hair which results in the second image being formed on the hair.

20. The method of claim 19, wherein after the step of applying the first image, an amount of gel composition remains in the distal space; however, subsequent application of force to the container results in additional gel composition passing through the screen and filling the distal space for application of the second image.

21. The method of claim 19, wherein a distal end of the stencil is placed in direct contact with the hair prior to applying force to the container to cause the gel composition to pass through the screen, fill the distal space and be applied onto the hair.
